(19) United States
(12) Patent Application Publication
(10) Pub. No.: US 2023/0043020 A1
(43) Pub. Date: Feb. 9, 2023

(54) IMAGE SCANNING DEVICE AND IMAGE SCANNING METHOD

(71) Applicant: Egis Technology Inc., Hsinchu City (TW)

(72) Inventors: Chen Yang, Hsinchu City (TW); Kuan-Yi Lin, Hsinchu City (TW); Chia-Wei Lin, Hsinchu City (TW); Yu-Hua Lin, Hsinchu City (TW); Chun-Ching Tseng, Hsinchu City (TW)

(73) Assignee: Egis Technology Inc., Hsinchu City (TW)

(21) Appl. No.: 17/790,133

(22) PCT Filed: Jun. 10, 2020
(86) PCT No.: PCT/CN2020/095329

§ 371 Date: Jun. 30, 2022

Related U.S. Application Data
(60) Provisional application No. 62/963,546, filed on Jan. 21, 2020.

(51) Int. Cl. G06V 40/12; G06V 40/13; G06V 10/26

(52) U.S. Cl. CPC G06V 40/1335; G06V 40/1318; G06V 10/26; G06V 40/1347

(57) ABSTRACT

The invention provides an image scanning device and an image scanning method. The image scanning device includes: a display that emits red light, green light, and blue light to expose an object when the object contacts the display; the sensor is arranged below the display, and the sensor obtains a first image corresponding to the red light, a second image corresponding to the green light and a third image corresponding to the blue light; and the processing module is coupled to the sensor and the display, and the processing module generates an object image corresponding to the object according to the first image, the second image and the third image.

### BACKGROUND

### Technology Field

The invention relates to an image scanning device and an image scanning method, and particularly, to an image scanning device and an image scanning method capable of acquiring complete image information.

### Description of Related Art

At present, in fingerprint identification solutions of electronic devices, the under-screen fingerprint identification technology in which a user directly touches the screen for fingerprint identification has gradually become the mainstream. If the area of the fingerprint identification sensor under the screen is increased, the technical effect of performing fingerprint identification at multiple positions on the screen can be achieved. However, conventional electronic devices do not use the under-screen fingerprint identification sensor for applications other than the fingerprint identification, which wastes the image acquisition function of the under-screen fingerprint identification sensor. Therefore, the application of the under-screen fingerprint identification sensor to fields other than the fingerprint identification is the goal that those skilled in the art should strive for.

### SUMMARY

In view of this, the invention provides an image scanning device and an image scanning method, which can acquire complete image information.

The invention provides an image scanning device which includes a display emitting red light, green light and blue light respectively to expose an object when the object is in contact with the display; a sensor disposed below the display and obtaining a first image corresponding to the red light, a second image corresponding to the green light, and a third image corresponding to the blue light; and a processing module coupled to the sensor and the display and generating an object image corresponding to the object according to the first image, the second image, and the third image.

The invention provides an image scanning method adapted for an image scanning device. The image scanning device includes a display and a sensor disposed below the display. The image scanning method includes steps as follows. The display emits red light, green light, and blue light respectively to expose an object when the object is in contact with the display; a first image corresponding to the red light, a second image corresponding to the green light, and a third image corresponding to the blue light are obtained by the sensor; and an object image corresponding to the object is generated according to the first image, the second image, and the third image.

In summary, in the image scanning device and the image scanning method of the invention, the sensor is disposed below the display. The display emits red light, green light, and blue light to expose the object when the object is in contact with the display, the sensor obtains the first image, the second image, and the third image, and then the processing module generates the object image according to the first image, the second image, and the third image. Since the object is in direct contact with the display and the light source is emitted by the display, the generated object image may not be subjected to the interference of the external light source nor to the distortion of the image capturing edge of the lens.

In order to make the features and advantages of the invention comprehensible, embodiments accompanied with drawings are described in detail below.

### BRIEF DESCRIPTION OF THE DRAWING

The accompanying drawings are included to provide a further understanding of the invention, and are incorporated in and constitute a part of this specification. The drawings illustrate embodiments of the invention and together with the description serve to explain the principles of the invention.

FIG. 1A and FIG. 1B are schematic views of an image scanning device according to an embodiment of the invention.

FIG. 2 is a flowchart illustrating an image scanning method according to an embodiment of the invention.

### DESCRIPTION OF REFERENCE NUMERALS

100: image scanning device
110: display
120: sensor
130: processing module
S201-S204: steps of an image scanning method

### DESCRIPTION OF THE EMBODIMENTS

Reference will now be made in detail to the exemplary embodiments of the invention, examples of which are illustrated in the accompanying drawings. Whenever possible, the same reference numerals are used to represent the same or similar parts in the accompanying drawings and description.

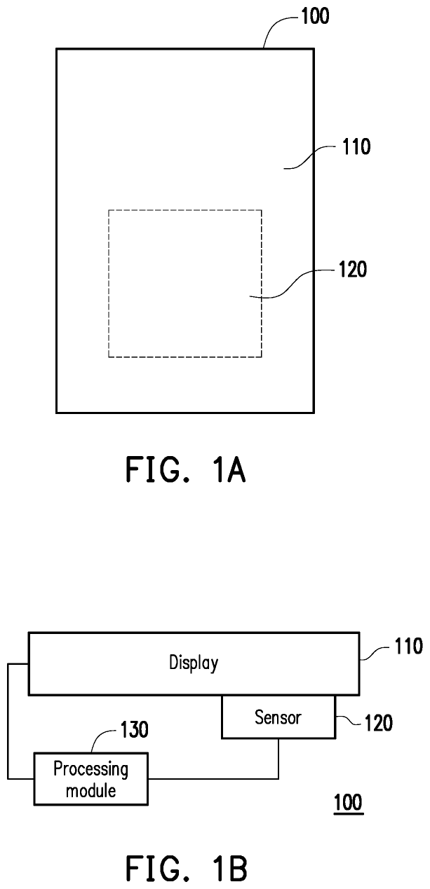

FIG. 1A and FIG. 1B are schematic views of an image scanning device according to an embodiment of the invention.

Referring to FIG. 1A and FIG. 1B, in an embodiment of the invention, an image scanning device 100 includes a display 110, a sensor 120, and a processing module 130. The sensor 120 is disposed below the display 110. The processing module 130 is coupled to the display 110 and the sensor 120. The display 110 is an organic light emitting diode (OLED) display or other similar components, for example. In one embodiment, the display 110 may integrate touch sensing components therein. The sensor 120 is a thin film transistor (TFT) sensor or other similar components, for example. The processing module 130 is a central processing unit (CPU), an application processor (AP), or other programmable general-purpose or special-purpose microprocessor, a digital signal processor (DSP), a programmable controller, an application specific integrated circuit (ASIC), a programmable logic device (PLD), or a combination thereof, for example.

In one embodiment, when an object to be measured (e.g. a business card and the like) is in contact with the display 110 (e.g., the object to be measured is disposed on the display 110), the processing module 130 may instruct the display 110 to emit red light, green light, and blue light respectively to expose the object, and the sensor 120 obtains a first image corresponding to red light, a second image corresponding to green light, and a third image corresponding to blue light. The processing module 130 generates an object image corresponding to the object according to the first image, the second image, and the third image. Since the sensor 120 has a large sensing area, the object image generated by the processing module 130 is a one-to-one color scan image of the corresponding object, and the object image can represent the complete data of the object.

The sensor 120 is disposed below the display 110, so the first image, the second image, and the third image obtained by the sensor 120 may include images of components such as wires and fences between the top of the sensor 120 and the display 110. The processing module 130 first performs a background subtraction operation (i.e., the backgrounds are removed in the images) on the first image, the second image, and the third image, and then generates an object image according to the first image, the second image, and the third image after subtracting the backgrounds. For example, the processing module 130 may determine image pixels of the components and image pixels of the non-component in the first image (or the second image, the third image). For each image pixel of the components, the processing module 130 may obtain the image pixels of the non-component around the image pixel of the components to calculate the pixel value by interpolation, and replace the image pixel of the components with the calculated result to complete the background subtraction operation.

In one embodiment, the processing module 130 calculates the mixing ratio of the red, green, and blue according to the first image, the second image, and the third image after subtracting the backgrounds. Moreover, an object image is generated according to the mixing ratio of the red, green, and blue as well as the first image, the second image, and the third image after subtracting the backgrounds. For example, the processing module 130 may calculate the red channel grayscale value of each pixel in the first image, the green channel grayscale value of each pixel in the second image, and the blue channel grayscale value of each pixel in the third image after subtracting the background, and the processing module 130 may mix the red channel grayscale value, the green channel grayscale value, and the blue channel grayscale value of each pixel to restore the color of the object to generate a color object image.

In one embodiment, if the area of the object is greater than the area of the sensor 120, the processing module 130 obtains multiple stitched images of the object and matches multiple feature points of the object in the multiple stitched images to stitch the multiple stitched images into an object image. Each stitched image can be obtained by being exposed to red light, green light and blue light respectively emitted by the display 110 three times, by subtracting the background, and then by performing color restoration. Specifically, when the area of the object is greater than the area of the sensor 120, the user can perform a swipe operation on the object on the sensor 120 to obtain multiple stitched images of the object. The processing module 130 can identify one or more feature points on each stitched image, match the common feature points of any two or more stitched images to perform image stitching, and then stitch multiple stitched images into a complete object image.

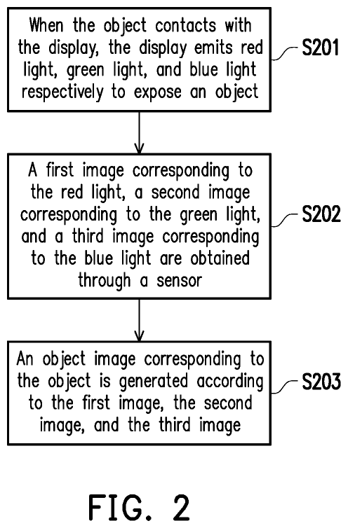

FIG. 2 is a flowchart illustrating an image scanning method according to an embodiment of the invention.

Referring to FIG. 2, in step S201, when the object is in contact with the display, the display emits red light, green light, and blue light respectively to expose the object.

In step S202, the first image corresponding to the red light, the second image corresponding to the green light, and the third image corresponding to the blue light are obtained through the sensor.

In step S203, an object image corresponding to the object is generated according to the first image, the second image, and the third image.

In summary, in the image scanning device and the image scanning method of the invention, the sensor is disposed below the display. The display emits red light, green light, and blue light to expose the object when the object is in contact with the display, the sensor obtains the first image, the second image, and the third image, and then the processing module generates the object image according to the first image, the second image, and the third image. Since the object is in direct contact with the display and the light source is emitted by the display, the generated object image may not be subjected to the interference of the external light source nor to the distortion of the image capturing edge of the lens.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An image scanning device, comprising:
a display emitting red light, green light, and blue light, respectively to expose an object when the object is in contact with the display;
a sensor disposed below the display, wherein the sensor obtains a first image corresponding to the red light, a second image corresponding to the green light, and a third image corresponding to the blue light; and
a processing module coupled to the sensor and the display, wherein the processing module generates an object image corresponding to the object according to the first image, the second image, and the third image.

2. The image scanning device according to claim 1, wherein the processing module subtracts the backgrounds in the first image, the second image, and the third image and generates the object image according to the first image, the second image, and the third image after subtracting the backgrounds.

3. The image scanning device according to claim 2, wherein the background comprises images of components between the sensor and the display.

4. The image scanning device according to claim 2, wherein the processing module calculates a mixing ratio of red, green, and blue according to the first image, the second image, and the third image after subtracting the backgrounds, and the processing module generates the object image according to the mixing ratio of red, green, and blue and the first image, the second image, and the third image after subtracting the backgrounds.

5. The image scanning device according to claim 1, wherein if an area of the object is greater than an area of the sensor, the processing module obtains a plurality of stitched images of the object and matches a plurality of feature points of the object in the plurality of the stitched images to stich the plurality of stitched images into the object image.

6. The image scanning device according to claim 1, wherein the display is an organic light emitting diode display.

7. The image scanning device according to claim 1, wherein the sensor is a thin film transistor sensor.

8. An image scanning method, adapted for an image scanning device, wherein the image scanning device comprises a display and a sensor disposed below the display, wherein the image scanning method comprises:
exposing an object by red light, green light, and blue light respectively emitted by the display when the object is in contact with the display;
obtaining a first image corresponding to the red light, a second image corresponding to the green light, and a third image corresponding to the blue light by the sensor; and
generating an object image corresponding to the object according to the first image, the second image, and the third image.

9. The image scanning method according to claim 8, wherein the step of generating the object image corresponding to the object according to the first image, the second image, and the third image comprises subtracting backgrounds in the first image, the second image, and the third image, and generating the object image according to the first image, the second image, and the third image after subtracting the backgrounds.

10. The image scanning method according to claim 9, wherein the backgrounds comprise images of components between the sensor and the display.

11. The image scanning method according to claim 9, wherein the step of generating the object image corresponding to the object according to the first image, the second image, and the third image further comprises: calculating a mixing ratio of red, green, and blue according to the first image, the second image, and the third image after subtracting the backgrounds, and generating the object image according to the mixing ratio of red, green, and blue and the first image, the second image, and the third image after subtracting the backgrounds.

12. The image scanning method according to claim 8, further comprising: obtaining a plurality of stitched images of the object if an area of the object is greater than an area of the sensor, and matching a plurality of feature points of the object in the plurality of stitched images to stitch the plurality of stitched images into the object image.
